(19) United States
(12) Patent Application Publication
(10) Pub. No.: US 2025/0166919 A1
(43) Pub. Date: May 22, 2025

(54) FILM CAPACITOR

(71) Applicants: Murata Manufacturing Co., Ltd., Nagaokakyo-shi (JP); Shizuki Electric Co., Inc., Nishinomiya-shi (JP)

(72) Inventors: Tomoki INAKURA, Nagaokakyo-shi (JP); Atsushi KAWABATA, Nishinomiya-shi (JP)

(21) Appl. No.: 19/032,667

(22) Filed: Jan. 21, 2025

Related U.S. Application Data
(63) Continuation of application No. PCT/JP2023/018562, filed on May 18, 2023.

(30) Foreign Application Priority Data
Jul. 22, 2022 (JP) 2022-117415

(51) Int. Cl. H01G 4/236; H01G 4/224; H01G 4/32

(52) U.S. Cl. CPC H01G 4/236; H01G 4/32; H01G 4/224

(57) ABSTRACT

A film capacitor that includes: a capacitor element including an element body having a laminate including a metallized film having a metal layer on at least one main surface of a dielectric film, and an external electrode on the end surface of the element body and connected to the metal layer; and a lead-out terminal welded and electrically connected to the external electrode, in which the external electrode has a surface roughness Ra of 20 μm to 45 μm, and a bite depth of the lead-out terminal from a surface of the external electrode is 0.5 mm or more.

### CROSS REFERENCE TO RELATED APPLICATIONS

The present application is a continuation of International application No. PCT/JP2023/018562, filed May 18, 2023, which claims priority to Japanese Patent Application No. 2022-117415, filed Jul. 22, 2022, the entire contents of each of which are incorporated herein by reference.

### TECHNICAL FIELD

The present disclosure relates to a film capacitor.

### BACKGROUND ART

As a type of capacitor, a film capacitor is known which is structured so that a flexible resin film is used as a dielectric film and metal layers facing each other with the dielectric film interposed therebetween are arranged. A capacitor element constituting the film capacitor is produced, for example, by producing a laminate in which metallized films each having the metal layer provided on the surface of the dielectric film are wound or stacked, and then forming an external electrode (also referred to as a metallicon electrode) on each end surface of the laminate.

To the external electrode of the capacitor element, a lead-out terminal, such as a lead wire or a busbar, is connected. Examples of a method for connecting the lead-out terminal include a method for joining the lead-out terminal to the external electrode of the capacitor element by soldering or resistance welding or the like.

Patent Literature 1 discloses a metallized film capacitor including a capacitor element having a wound or stacked metallized film and a metallicon electrode, and a metal bar solder-connected to the metallicon electrode, in which the metal bar is provided with a projection part for solder connection. According to Patent Literature 1, the metal bar having a cross-sectional area required for a circuit is used for a lead electrode joined to the capacitor element, thereby achieving a structure allowing the flow of a large current and, due to the projection part for solder connection provided on the metal bar, only the solder connection range is heated in solder connection, thereby reducing thermal influence on the capacitor element, so that the reliability of the joint of the lead electrode and the capacitor characteristics can be secured.

Patent Literature 2 discloses a film capacitor including a capacitor element, a metallicon electrode formed by spraying molten metal of lead or tin, for example, on each end surface of the capacitor element, and one and the other lead wires connected and fixed to the metallicon electrodes by an electric welder, for example. In the film capacitor described in Patent Literature 2, the surface of any one of the metallicon bonding surfaces of the lead wires is continuously formed to have a substantially mountain shape or a substantially saw tooth shape in the vertical direction.
Patent Literature 1: JP 2004-349447 A
Patent Literature 2: JP 2008-166457 A

### SUMMARY OF THE DISCLOSURE

As described in Patent Literature 1, in the method for joining the lead-out terminal, such as a lead wire, to the external electrode of the capacitor element by soldering, a hot soldering iron is brought into contact with a joint portion, and therefore the heat of the soldering iron is transmitted to the inside of the capacitor element through the external electrode. As a result, the capacitor element is damaged by the heat, posing a risk of a decrease in the performance of the film capacitor.

On the other hand, in the method for joining the lead-out terminal, such as a lead wire, to the external electrode of the capacitor element by resistance welding as described in Patent Literature 2, the lead-out terminal is welded to the external electrode by passing a large current from a welding electrode in a state where the external electrode and the lead-out terminal are pressed against each other by the welding electrode.

Although the resistance welding uses a large current, the time in which the large current flows is very short, and therefore damage caused by the heat to the capacitor element is reduced as compared with the damage caused by soldering. However, it can be said that there is room for improvement from the viewpoint of enhancing the bonding strength between the external electrode and lead-out terminal of the capacitor element.

It is an object of the present disclosure to provide a film capacitor having high bonding strength between the lead-out terminal and the external electrode of the capacitor element.

A film capacitor of the present disclosure includes: a capacitor element including an element body having a laminate including a metallized film having a metal layer on at least one main surface of a dielectric film, and an external electrode on the end surface of the element body and connected to the metal layer; and a lead-out terminal welded and electrically connected to the external electrode, in which the external electrode has a surface roughness Ra of 20 μm to 45 μm, and a bite depth of the lead-out terminal from a surface of the external electrode is 0.5 mm or more.

The present disclosure can provide a film capacitor having high bonding strength between the lead-out terminal and the external electrode of the capacitor element.

### BRIEF DESCRIPTION OF THE DRAWINGS

FIG. 1 is a perspective view schematically illustrating a film capacitor according to one embodiment of the present disclosure.

FIG. 2 is a front view of the film capacitor illustrated in FIG. 1.

FIG. 3A is a side view schematically illustrating one example of an external electrode and a lead-out terminal before welding. FIG. 3B is a side view schematically illustrating one example of the external electrode and the lead-out terminal after welding.

FIG. 4A is a front view schematically illustrating one example of the external electrode and the lead-out terminal before welding. FIG. 4B is a front view schematically illustrating one example of the external electrode and the lead-out terminal after welding.

FIG. 5 is a front view schematically illustrating one example of the lead-out terminal biting into the external electrode.

FIG. 6 is a front view schematically illustrating another example of the lead-out terminal biting into the external electrode.

FIG. 7 is a perspective view schematically illustrating one example of a capacitor element constituting the film capacitor of the present disclosure.

FIG. 8 is a cross-sectional view along the b-b line of the capacitor element illustrated in FIG. 7.

FIG. 9 is a perspective view schematically illustrating one example of an element body constituting the capacitor element illustrated in FIGS. 7 and 8.

FIG. 10 is a perspective view schematically illustrating another example of the element body constituting the capacitor element illustrated in FIGS. 7 and 8.

FIGS. 11A and 11B are perspective views schematically illustrating one example of a method for using the film capacitor illustrated in FIG. 1.

FIG. 12 is a schematic view for explaining a tensile test.

### DESCRIPTION OF THE PREFERRED EMBODIMENTS

Hereinafter, a capacitor of the present disclosure is described. The present disclosure is not limited to the following configurations and may be altered as appropriate to such an extent that the gist of the present disclosure is not altered. The present disclosure also includes combinations of a plurality of individual preferable configurations described below.

In this specification, terms indicating relations between elements (e.g., “perpendicular”, “parallel”, “orthogonal”, and the like) and terms indicating the shapes of the elements are not expressions expressing only strict meanings, but expressions expressing substantially equivalent ranges, and, for example, also including about a few percent difference.

The drawings described below are schematic views, and the dimensions, the scales of the aspect ratios, and the like are sometimes different from those of actual products.

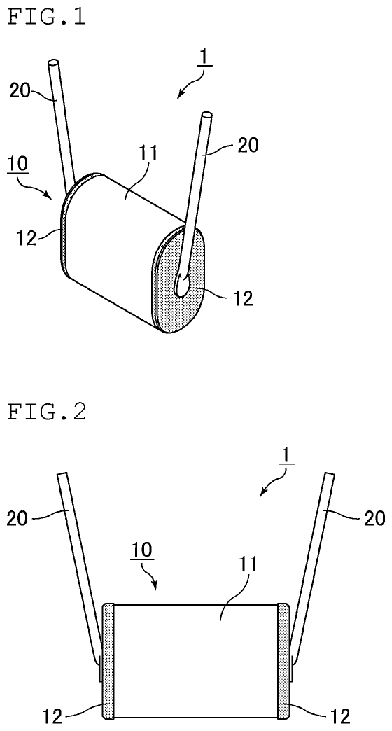

FIG. 1 is a perspective view schematically illustrating a film capacitor according to one embodiment of the present disclosure. FIG. 2 is a front view of the film capacitor illustrated in FIG. 1.

A film capacitor 1 illustrated in FIGS. 1 and 2 includes a capacitor element 10 and a lead-out terminal 20.

The capacitor element 10 includes an element body 11 and an external electrode 12 provided on an end surface of the element body 11. Specifically, each of the external electrodes 12 in a pair is provided on each end surface of the element body 11. The configuration of the capacitor element 10 is described later.

The lead-out terminal 20 is electrically connected to the external electrode 12. Specifically, each of the lead-out terminals 20 in a pair is electrically connected to each of the external electrodes 12 in a pair.

Each of the pair of lead-out terminals 20 may extend from each of the external electrodes 12 so that the distance between the lead-out terminals 20 increases as illustrated in FIG. 1 and FIG. 2. Alternatively, each of the pair of lead-out terminals 20 may extend from each of the external electrodes 12 so that the distance between the lead-out terminals 20 is constant.

The lead-out terminal 20 is welded to the external electrode 12. Specifically, the lead-out terminal 20 is resistance-welded to the external electrode 12.

As illustrated in FIGS. 1 and 2, a welded part of the lead-out terminal 20 may have a flat plate shape.

As one example, the lead-out terminal 20 is a lead wire. In this case, the lead wire may or may not have a plated layer on the surface thereof. The welded part of the lead wire may be processed into a flat plate shape.

As another example, the lead-out terminal 20 is a busbar. The busbar has a flat plate shape as a whole including the welded part.

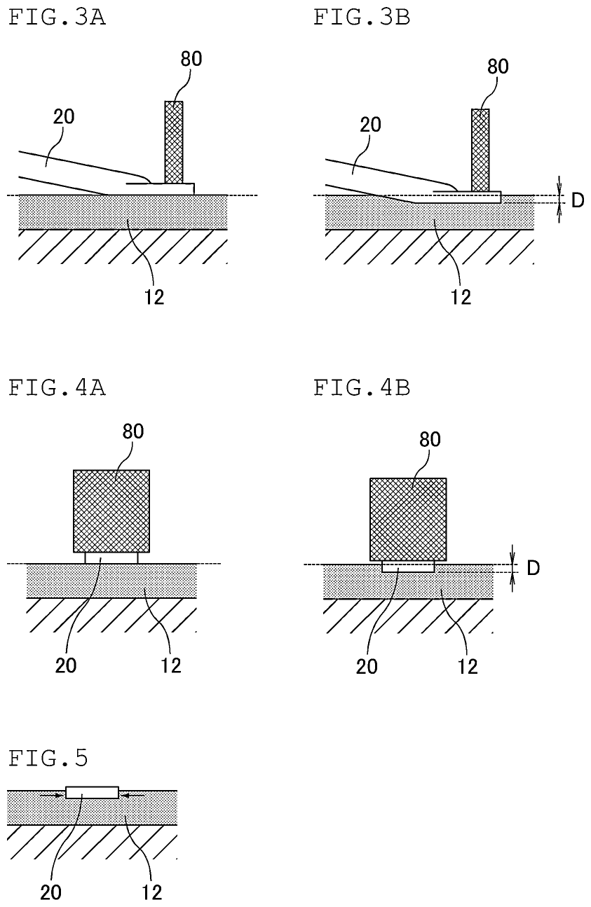

FIG. 3A is a side view schematically illustrating one example of the external electrode and the lead-out terminal before welding. FIG. 3B is a side view schematically illustrating one example of the external electrode and the lead-out terminal after welding. FIG. 4A is a front view schematically illustrating one example of the external electrode and the lead-out terminal before welding. FIG. 4B is a front view schematically illustrating one example of the external electrode and the lead-out terminal after welding.

As illustrated in FIG. 3A and FIG. 4A, in the resistance welding, a large current is passed from a welding electrode 80 in a state where the external electrode 12 and the lead-out terminal 20 are pressed against each other by the welding electrode 80. The large current generates heat at the interface between the external electrode 12 and the lead-out terminal 20, so that the external electrode 12 is softened. As a result, the lead-out terminal 20 bites into the external electrode 12 as illustrated in FIGS. 3B and 4B.

FIG. 5 is a front view schematically illustrating one example of the lead-out terminal biting into the external electrode.

When the lead-out terminal 20 bites into the external electrode 12, the external electrode 12 is subjected to the acting force indicated by the arrow in FIG. 5, making it hard for the lead-out terminal 20 to separate from the external electrode 12.

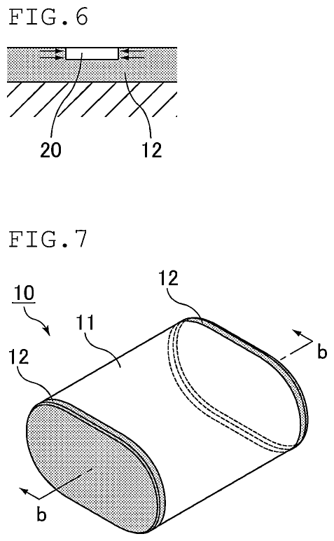

FIG. 6 is a front view schematically illustrating another example of the lead-out terminal biting into the external electrode.

As illustrated in FIG. 6, the lead-out terminal 20 may entirely bite into the external electrode 12.

The more the lead-out terminal 20 bites into the external electrode 12, the larger the contact area between the external electrode 12 and the lead-out terminal 20 becomes. Therefore, by increasing the bite depth of the lead-out terminal 20 from the surface of the external electrode 12, the bonding strength between the external electrode 12 and the lead-out terminal 20 can be increased.

In the film capacitor of the present disclosure, the bite depth of the lead-out terminal from the surface of the external electrode (length indicated by D in FIGS. 3B and 4B) is 0.5 mm or more.

As described in Examples described later, when the bite depth of the lead-out terminal from the surface of the external electrode is 0.5 mm or more, sufficient bonding strength can be secured.

Further, the bite depth of the lead-out terminal can be easily controlled by the displacement amount of a welder. This makes it possible to produce a film capacitor stable in quality.

Thus, in the film capacitor of the present disclosure, the bonding strength between the external electrode and the lead-out terminal can be controlled by the bite depth of the lead-out terminal. Therefore, sufficient bonding strength can be secured without alloying the lead-out terminal (e.g., plated layer provided on the surface of the lead wire) and the external electrode by welding. In the film capacitor of the present disclosure, the lead-out terminal and the external electrode may or may not be alloyed.

The bite depth of the lead-out terminal from the surface of the external electrode can be measured, for example, by measuring a welded point using 3D measurement of a digital microscope for a sample after subjected to welding strength measurement.

From the viewpoint of increasing the bonding strength between the external electrode and the lead-out terminal, the bite depth of the lead-out terminal from the surface of the external electrode is preferably 0.7 mm or more.

With respect to the upper limit of the bite depth of the lead-out terminal, the lead-out terminal can bite up to the thickness of the external electrode at the maximum. Therefore, the bite depth of the lead-out terminal from the surface of the external electrode is equal to or less than the thickness of the external electrode.

The lead-out terminal can bite into the external electrode only up to the thickness of the welded part. Therefore, the bite depth of the lead-out terminal from the surface of the external electrode is preferably equal to or less than the thickness of the welded part of the lead-out terminal.

To set the bite depth of the lead-out terminal from the surface of the external electrode to 0.5 mm or more, the thickness of the welded part of the lead-out terminal is preferably 0.5 mm or more. To set the bite depth of the lead-out terminal from the surface of the external electrode to 0.7 mm or more, the thickness of the welded part of the lead-out terminal is more preferably 0.7 mm or more. The upper limit of the thickness of the welded part of the lead-out terminal is not specified.

In the film capacitor of the present disclosure, the external electrode has a surface roughness Ra of 20 μm to 45 μm.

As described in Examples described later, when the external electrode has a surface roughness Ra of 20 μm to 45 μm, the welding can be performed at a temperature of 300° C. or less. This allows the lead-out terminal to bite into the external electrode in a short time without damaging the capacitor element.

In contrast thereto, when the surface roughness Ra of the external electrode exceeds 45 μm, problems, such as a decrease in strength of the external electrode and a decrease in moisture resistance, occur.

For the surface roughness Ra of the external electrode, three places of two places of both ends and a center part of the external electrode of the surface of the external electrode, for example, are measured with a laser microscope (manufactured by Keyence Corporation, VK-8700), and the average value can be set as the value of the surface roughness Ra.

In the film capacitor of the present disclosure, the element body constituting the capacitor element is a laminate including a metallized film having a metal layer provided on at least one main surface of the dielectric film, and the external electrode constituting the capacitor element is connected to the metal layer.

The laminate has, for example, a columnar shape having an oblong cross-section, and is provided with the external electrode formed, for example, by metal spraying (metallicon) on each end surface in the center axis direction.

The laminate may be a wound body in which the metallized film is wound in a stacked state.

Hereinafter, as one example of the film capacitor, a wound film capacitor is described in which the metallized films are wound in a stacked state, but a stacked film capacitor in which the metallized films are stacked may be acceptable.

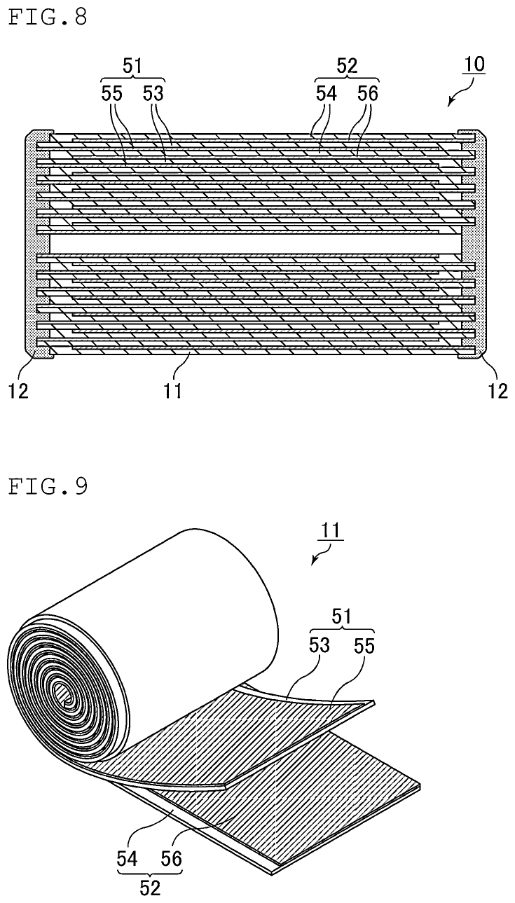

FIG. 7 is a perspective view schematically illustrating one example of the capacitor element constituting the film capacitor of the present disclosure. FIG. 8 is a cross-sectional view along the b-b line of the capacitor element illustrated in FIG. 7.

In the capacitor element 10 illustrated in FIGS. 7 and 8, the element body 11 is a laminate including a first metallized film 51 and a second metallized film 52. For example, the element body 11 is a wound body in which the first metallized film 51 and the second metallized film 52 are wound in a stacked state. To each end surface of the element body 11, each of the pair of external electrodes 12 is electrically connected.

As illustrated in FIG. 8, the first metallized film 51 includes a first dielectric film 53 and a first metal layer 55 provided on the surface of the first dielectric film 53, and the second metallized film 52 includes a second dielectric film 54 and a second metal layer 56 provided on the surface of the second dielectric film 54.

As illustrated in FIG. 8, the first metal layer 55 and the second metal layer 56 face each other with the first dielectric film 53 or the second dielectric film 54 interposed therebetween. Further, the first metal layer 55 is electrically connected to one external electrode 12, and the second metal layer 56 is electrically connected to the other external electrode 12.

The first dielectric film 53 and the second dielectric film 54 may have configurations different from each other, but preferably have the same configuration.

The first metal layer 55 is formed to reach one side edge but not to reach the other side edge on one surface of the first dielectric film 53. On the other hand, the second metal layer 56 is formed not to reach one side edge but to reach the other side edge on one surface of the second dielectric film 54. The first metal layer 55 and the second metal layer 56 are formed of an aluminum layer or the like, for example.

FIG. 9 is a perspective view schematically illustrating one example of the element body constituting the capacitor element illustrated in FIGS. 7 and 8.

As illustrated in FIGS. 8 and 9, the first dielectric films 53 and the second dielectric films 54 are stacked to be shifted in the width direction (left and right direction in FIG. 8) so that end parts reaching the side edges of the first dielectric films 53 in the first metal layers 55 and end parts reaching the side edges of the second dielectric films 54 in the second metal layers 56 are both exposed from the stacked films. As illustrated in FIG. 9, the element body 11 is formed into a wound body of the metallized films by the first dielectric films 53 and the second dielectric film 54 wound in a stacked state and is brought into a stacked state while holding the state where the first metal layers 55 and the second metal layers 56 are exposed in the end parts.

In FIGS. 8 and 9, the first metallized film 51 and the second metallized film 52 are wound so that the second dielectric film 54 is situated on the outside of the first dielectric film 53 and the first metal layer 55 and the second metal layer 56 face inward with respect to the first dielectric film 53 and the second dielectric film 54, respectively.

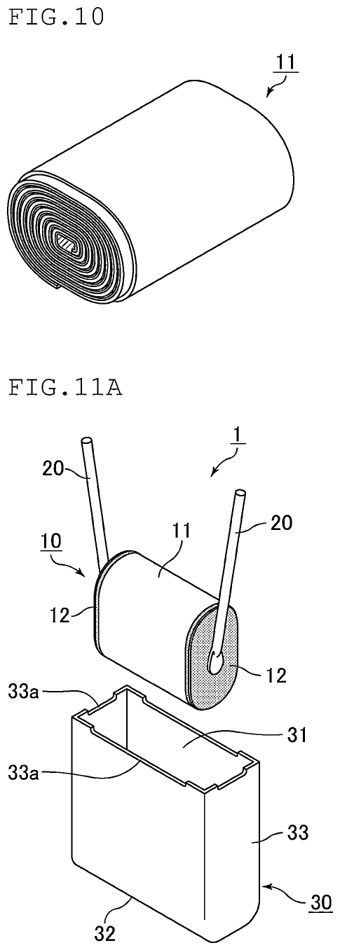

FIG. 10 is a perspective view schematically illustrating another example of the element body constituting the capacitor element illustrated in FIGS. 7 and 8.

When the element body 11 of the capacitor element is constituted by a wound body of the metallized films, the cross-sectional shape is preferably pressed into a flattened shape, such as an oval shape or an oblong shape, making the element body 11 more compact than that when the cross-sectional shape is a perfect circle, as illustrated in FIG. 10. In this case, the film capacitor can be made smaller as a whole.

The wound body of the metallized films may have a cylindrical winding shaft. The winding shaft is arranged on the center axis of the wound metallized films and serves as the winding shaft when the metallized films are wound.

The external electrode 12 is formed by thermal spraying, for example, zinc, onto each end surface of the element body 11 obtained as described above. One external electrode 12 contacts exposed end parts of the first metal layers 55 to be electrically connected to the first metal layers 55. The other external electrode 12 contacts exposed end parts of the second metal layers 56 to be electrically connected to the second metal layers 56.

In the film capacitor of the present disclosure, the dielectric film constituting the element body of the capacitor element may contain a curable resin as the main component or may contain a thermoplastic resin as the main component. From the viewpoint of enhancing the heat resistance of the film capacitor, the dielectric film preferably contains a curable resin as the main component.

In this specification, the “main component of the dielectric film” means a component having the largest weight percentage and preferably means a component having a weight percentage of more than 50% by weight. Therefore, the dielectric film may contain, as components other than main component, additives, such as a silicone resin, and uncured portions of starting materials, such as a first organic material and a second organic material, described later, for example.

The curable resin may be a thermosetting resin or a photocurable resin.

In this specification, the thermosetting resin means a resin that can be cured by heat, and a curing method is not limited. Therefore, a resin cured by methods other than heat (e.g., light, electron beams, and the like) is also included in the thermosetting resin insofar as the resin can be cured by heat. Depending on materials, a reaction sometimes starts due to the reactivity of the materials themselves, and thus materials that are cured without necessarily being exposed to external heat or light, for example, are also classified as the thermosetting resin. The same applies to the photocurable resin, and a curing method is not limited.

The curable resin may or may not have at least one of a urethane bond or a urea bond. Examples of such a resin include a urethane resin having a urethane bond, a urea resin having a urea bond, and the like. Further, a resin having both a urethane bond and a urea bond may be acceptable.

The presence of the urethane bond and/or the urea bond can be confirmed using a Fourier transform infrared spectrophotometer (FT-IR).

The curable resin preferably contains cured products of the first organic material and the second organic material. Examples of the cured product include a cured product obtained by reacting of a hydroxyl group (OH group) possessed by the first organic material with an isocyanate group (NCO group) possessed by the second organic material.

When the cured product is obtained by the reaction above, uncured portions of starting materials may remain in the film. For example, the dielectric film may contain at least one of the isocyanate group or the hydroxyl group. In this case, the dielectric film may contain either the isocyanate group or the hydroxyl group or may contain both the isocyanate group and the hydroxyl group.

The presence of the isocyanate group and/or the hydroxyl group can be confirmed using a Fourier transform infrared spectrophotometer (FT-IR).

The first organic material is preferably polyol having a plurality of hydroxyl groups in the molecule. Examples of the polyol include polyether polyol, polyester polyol, polyvinyl acetal, and other polyols. As the first organic material, two or more organic materials may be used in combination.

The second organic material is preferably an isocyanate compound, an epoxy resin, or a melamine resin, each having a plurality of functional groups in the molecule. As the second organic material, two or more organic materials may be used in combination. Among the second organic materials, the isocyanate compound is desirable.

Examples of the isocyanate compound include aromatic polyisocyanates, such as diphenylmethane diisocyanate (MDI) and tolylene diisocyanate (TDI), aliphatic polyisocyanates, such as hexamethylene diisocyanate (HDI), and the like. Modified substances of these polyisocyanates, e.g., modified substances having carbodiimide or urethane, for example, may be acceptable.

The epoxy resin is not limited insofar as it is a resin having an epoxy ring. Examples thereof include a bisphenol A-type epoxy resin, a biphenyl-backbone epoxy resin, a cyclopentadiene-backbone epoxy resin, and a naphthalene-backbone epoxy resin.

The melamine resin is not limited insofar as it is an organic nitrogen compound having a triazine ring in the center of the structure and three amino groups on the periphery of the structure. Examples thereof include an alkylated melamine resin and the like. In addition thereto, modified substances of melamine may be acceptable.

In the film capacitor of the present disclosure, the dielectric film constituting the element body of the capacitor element is preferably obtained by molding a resin solution containing the first organic material and the second organic material into a film, and then heat-treating the film for curing.

In the film capacitor of the present disclosure, the dielectric film constituting the element body of the capacitor element may contain a vapor-deposited polymerized film as the main component. The vapor-deposited polymerized film may or may not have at least one of a urethane bond or a urea bond.

The vapor-deposited polymerized film refers to one formed by a vapor deposition polymerization method, and is basically included in the curable resin.

In the film capacitor of the present disclosure, the dielectric film constituting the element body of the capacitor element may contain a thermoplastic resin as the main component. Examples of the thermoplastic resin include polypropylene, polyethersulfone, polyetherimide, polyarylate, and the like.

In the film capacitor of the present disclosure, the dielectric film constituting the element body of the capacitor element can also contain additives for adding other functions. For example, smoothness can be imparted by adding a leveling agent. The additives are more preferably materials having a functional group reacting with the hydroxyl group and/or the isocyanate group and forming part of the crosslinked structure of the cured product. Examples of such materials include a resin having at least one functional group selected from the group consisting of an epoxy group, a silanol group, and a carboxyl group and the like.

In the film capacitor of the present disclosure, the thickness of the dielectric film constituting the element body of the capacitor element is not limited, and may be set as appropriate according to the required capacitance and the required element volume of the capacitor to be produced.

The thickness of the dielectric film can be measured using an optical thickness gauge.

In the film capacitor of the present disclosure, the kind of the metal contained in the metal layer constituting the element body of the capacitor element is not limited. The metal layer preferably contains any one selected from the group consisting of aluminum (Al), titanium (Ti), zinc (Zn), magnesium (Mg), tin (Sn), and nickel (Ni).

In the film capacitor of the present disclosure, the thickness of the metal layer constituting the element body of the capacitor element is not limited. From the viewpoint of suppressing damage to the metal layer, the metal layer preferably has a thickness of 5 nm to 40 nm.

The thickness of the metal layer can be specified by observing a cross-section of the metallized film cut in the thickness direction using an electron microscope, such as a field emission scanning electron microscope (FE-SEM).

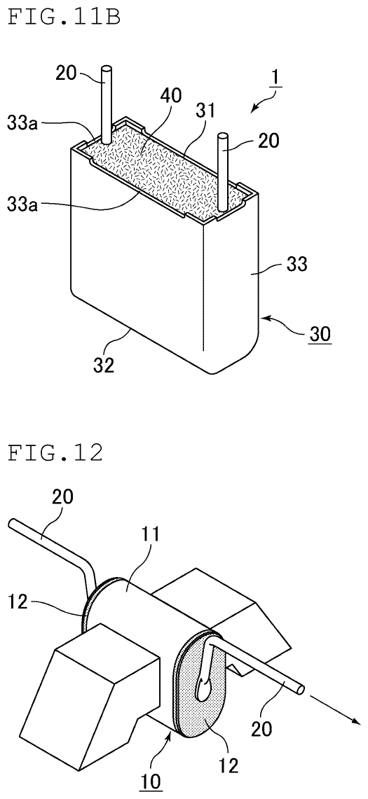

FIGS. 11A and 11B are perspective views schematically illustrating one example of a method for using the film capacitor illustrated in FIG. 1.

As illustrated in FIG. 11A, first, the film capacitor 1 is housed in the outer case 30.

The outer case 30 may be a resin case or may be a metal case.

In the example illustrated in FIG. 11A, the outer case 30 has a rectangular parallelepiped space formed thereinside. Although not illustrated in FIG. 11A, the capacitor element 10 is preferably arranged in the center inside the outer case 30 while being spaced away from the inner surface of the outer case 30.

The outer case 30 has a bottomed tubular shape having the opening part 31 in one end. In such a case, the outer case 30 includes a bottom wall 32 sealing the other end while facing the opening part 31, and a side wall 33 projecting toward the opening part 31 from the bottom wall 32.

In the example illustrated in FIG. 11A, the outer case 30 has a bottomed quadrangular tubular shape having the opening part 31 of a substantially rectangular shape in one end and including the bottom wall 32 sealing the other end while facing the opening part 31, and the side wall 33 of a quadrangular tubular shape projecting toward the opening part 31 from the bottom wall 32. The outer case 30 may have a shape, such as a bottomed tubular shape including the side wall 33 of a cylindrical shape in place of the side wall 33 of the quadrangular tubular shape.

As illustrated in FIG. 11A, the side wall 33 of the outer case 30 is preferably provided with a recess part 33a on the edge on the opening part 31 side. By providing the recess part(s) 33a in the opening surface of the outer case 30, when the film capacitor is mounted on a board, an increase in internal pressure due to sealing of the film capacitor and the board can be prevented. The outer case 30 does not have to be provided with the recess part(s) 33a.

Although not illustrated in FIG. 11A, the outer case 30 may be provided with guide groove(s) for regulating the position of the lead-out terminal 20 on the inner surface of the outer case 30.

Next, the inside of the outer case 30 is filled with a filling resin 40 as illustrated in FIG. 11B, thereby covering the periphery of the film capacitor 1 with the filling resin 40 and sealing the opening part 31 of the outer case 30. The lead-out terminal 20 projects outward from the inside of the outer case 30. As illustrated in FIG. 11B, the distance between the pair of lead-out terminals 20 is preferably constant.

As the filling resin 40, a resin according to the required function can be selected as appropriate. Examples of the filling resin 40 include an epoxy resin, a silicone resin, a urethane resin, and the like. As a curing agent for the epoxy resin, an amine curing agent and an imidazole curing agent, for example, may be used. As the filling resin 40, only resin may be used, and reinforcing agents may be added to enhance strength. As the reinforcing agents, inorganic fillers, such as silica and alumina, organic fillers, such as polyethylene fibers and polyamide fibers, and organic-inorganic composite fillers in which the surface of an inorganic powder is coated with an organic material, such as a silane coupling agent, for example, are used.

The relation between the height of the filling resin 40 and the height of the outer case 30 is such that the resin in the opening part 31 of the outer case 30 is as thick as possible, and the filling resin 40 may be positioned at an inner position of the outer case 30, may be positioned at almost the same height as the height of the outer case 30, or may overflow slightly due to surface tension.

The film capacitor of the present disclosure is not limited to the embodiments above insofar as the lead-out terminal is welded to the external electrode, the external electrode has a surface roughness Ra of 20 μm to 45 μm, and the bite depth of the lead-out terminal from the surface of the external electrode is 0.5 mm or more. Therefore, various applications and modifications can be made to the configuration, manufacturing conditions, and the like of the film capacitor within the scope of the present disclosure.

In the film capacitor of the present disclosure, when each of the pair of external electrodes is provided on each end surface of the element body and each of the pair of lead-out terminals is electrically connected to each of the pair of external electrodes, at least one external electrode and the lead-out terminal electrically connected to the external electrode may satisfy the relation described in the embodiment above.

FIGS. 11A and 11B illustrate the example in which a single capacitor element is housed in a single outer case. However, as described in, for example, JP 2012-69840 A, a plurality of capacitor elements may be housed in a single outer case.

In the film capacitor of the present disclosure, a portion where the lead-out terminal, such as a lead wire, is electrically connected to the external electrode of the capacitor element is provided in a small region of the external electrode, and therefore, when load is applied to the lead-out terminal, there is a risk that the lead-out terminal is disconnected from the external electrode. Therefore, inside the outer case, the filling resin is preferably positioned on the outside of the lead-out terminal and the external electrode of the capacitor element and closely fixes the external electrode and the lead-out terminal. Thus, even when load is applied to a projection part of the lead-out terminal, the filling resin reinforces the connection between the lead-out terminal and the external electrode, and can suppress the disconnection between the lead-out terminal and the external electrode.

The connection position between the external electrode and the lead-out terminal is not limited, and may be, for example, situated in a center part of the external electrode as illustrated in FIG. 1, on the opening part side of the case as illustrated in FIG. 1 of JP 4733566 B, or on the bottom side of the case.

This specification discloses the following items.
<1> A film capacitor that includes: a capacitor element including an element body having a laminate including a metallized film having a metal layer on at least one main surface of a dielectric film, and an external electrode on the end surface of the element body and connected to the metal layer; and a lead-out terminal welded and electrically connected to the external electrode, in which the external electrode has a surface roughness Ra of 20 μm to 45 μm, and a bite depth of the lead-out terminal from a surface of the external electrode is 0.5 mm or more.
<2> The film capacitor according to <1>, in which the bite depth of the lead-out terminal from the surface of the external electrode is 0.7 mm or more.
<3> The film capacitor according to <1> or <2>, in which the bite depth of the lead-out terminal from the surface of the external electrode is equal to or less than the thickness of a welded part of the lead-out terminal.
<4> The film capacitor according to any one of <1> to <3>, in which the welded part of the lead-out terminal has a thickness of 0.5 mm or more.
<5> The film capacitor according to any one of <1> to <4>, in which the welded part of the lead-out terminal has a flat plate shape.
<6> The film capacitor according to any one of <1> to <5>, in which the lead-out terminal is a lead wire.
<7> The film capacitor according to any one of <1> to <6>, in which the laminate is a wound body.

### EXAMPLES

Hereinafter, Examples in which the film capacitor of the present disclosure is specifically disclosed are described. It should be noted that the present disclosure is not limited to only Examples.

A film capacitor having a configuration similar to that of FIG. 1 was prepared.

As the lead-out terminal, a lead wire having an outer diameter of 1.2 mm was used. A welded part of the lead wire was processed into a flat plate shape having a thickness of 0.75 mm.

By changing the thermal spraying conditions (e.g., spray pressure) in the formation of the external electrode, the surface roughness Ra of the external electrode was adjusted to fall within the range of 20 μm to 45 μm.

By changing the displacement amount of a welder, the bite depth of the lead wire as the lead-out terminal was changed in the range of 0.2 mm to 0.75 mm.

The film capacitor was evaluated for the bonding strength between the external electrode and the lead-out terminal by a tensile test described below.

FIG. 12 is a schematic view for explaining the tensile test.

In a state where the capacitor element 10 to which the lead-out terminal 20 was connected was fixed and the lead-out terminal 20 was bent in the winding axis direction (direction indicated by the arrow in FIG. 12) as illustrated in FIG. 12, the tensile strength in the same axis direction was measured.

One lead-out terminal was pulled outward in the winding axis direction, and the tensile strength when the lead-out terminal was separated from the external electrode was measured using a digital force gauge (manufactured by IMADA Co., Ltd., ZTA-50N). This tensile strength was defined as the bonding strength between the external electrode and the lead-out terminal. Table 1 shows the results.

A case where the bonding strength is 7 N or more, desirably 8 N or more, was evaluated as having sufficient bonding strength. In Table 1, a case where the minimum value of the bonding strength is less than 7 N is indicated as “Bad”, a case where the minimum value is 7 N to less than 8 N is indicated as “Good”, and a case where the minimum value is 8 N or more is indicated as “Excellent”.

TABLE 1

| Bite depth of | Bonding strength [N] | | | |
|---|---|---|---|---|
| lead wire | Average | Maximum | Minimum | |
| [mm] | value | value | value | Evaluation |
| 0.20 to 0.29 | 5.1 | 7.2 | 4.0 | Bad |
| 0.30 to 0.39 | 6.3 | 7.5 | 4.1 | Bad |
| 0.40 to 0.49 | 7.7 | 9.9 | 6.7 | Bad |
| 0.50 to 0.59 | 8.8 | 12.4 | 7.3 | Good |
| 0.60 to 0.69 | 10.7 | 12.8 | 7.8 | Good |
| 0.70 to 0.75 | 13.2 | 14.9 | 10.3 | Excellent |

Table 1 shows that there is a correlation between the bite depth of the lead wire and the bonding strength and that, when the bite depth of the lead wire is 0.5 mm or more, sufficient bonding strength can be secured.

When the surface roughness Ra of the external electrode was 20 μm to 45 μm, the temperature at which the dimensional change rate measured by a thermomechanical analysis (TMA) reached 5% was 300° C. or less in all cases. In contrast thereto, when the surface roughness Ra of the external electrode was 12 μm, for example, the temperature at which the dimensional change rate measured by TMA reached 5% was 383° C. From these results, it is considered that, when the external electrode has a surface roughness Ra of 20 μm to 45 μm, welding can be performed at a temperature of 300° C. or less, and therefore the lead-out terminal can be made to bite into the external electrode in a short time without damaging the capacitor element.

The dimensional change rate of the external electrode is calculated as follows.

### <TMA Measurement Mode>

### Penetration Mode

### <TMA Measurement Method: Calculation of Dimensional Change Rate>

The external electrode was cut into a predetermined size to be used as a sample. The size of the sample may be about 5 mm×5 mm. An indenter is placed at the center of the surface of the sample, and the sample is heated to 450° C. at a temperature increase rate of 10° C./min while a 100 gf load is being applied to the indenter. The penetration depth of the indenter from the start of the measurement until the sample is heated to 450° C. is measured. This penetration depth is divided by the thickness of the sample, and the obtained value is multiplied by 100. This operation is also carried out for four samples cut from other portions of the external electrode. The average value of the obtained five values is defined as the dimensional change rate of the external electrode.

More specifically, it is meant that, when the external electrode has a surface roughness Ra of 20 μm to 45 μm, the temperature at which the dimensional change rate of the external electrode reached 5% (temperature at which the indenter penetrated by 5%) in the measurement after the temperature was increased to 450° C. was 300° C. or less in all cases.

### REFERENCE SIGNS LIST

1 film capacitor
10 capacitor element
11 element body
12 external electrode
20 lead-out terminal
30 outer case
31 opening part
32 bottom wall
33 side wall
33a recess part
40 filling resin
51 first metallized film
52 second metallized film
53 first dielectric film
54 second dielectric film
55 first metal layer
56 second metal layer
80 welding electrode
D bite depth of lead-out terminal from surface of external electrode

1. A film capacitor comprising:
a capacitor element including an element body comprising a laminate including a metallized film having a metal layer on at least one main surface of a dielectric film, and an external electrode on an end surface of the element body and connected to the metal layer; and
a lead-out terminal welded and electrically connected to the external electrode, wherein
the external electrode has a surface roughness Ra of 20 μm to 45 μm, and
a bite depth of the lead-out terminal from a surface of the external electrode is 0.5 mm or more.

2. The film capacitor according to claim 1, wherein the bite depth of the lead-out terminal from the surface of the external electrode is 0.7 mm or more.

3. The film capacitor according to claim 2, wherein the bite depth of the lead-out terminal from the surface of the external electrode is equal to or less than a thickness of a welded part of the lead-out terminal.

4. The film capacitor according to claim 1, wherein the bite depth of the lead-out terminal from the surface of the external electrode is equal to or less than a thickness of a welded part of the lead-out terminal.

5. The film capacitor according to claim 1, wherein a welded part of the lead-out terminal has a thickness of 0.5 mm or more.

6. The film capacitor according to claim 1, wherein a welded part of the lead-out terminal has a thickness of 0.7 mm or more.

7. The film capacitor according to claim 1, wherein a welded part of the lead-out terminal has a flat plate shape.

8. The film capacitor according to claim 1, wherein the lead-out terminal is a lead wire.

9. The film capacitor according to claim 1, wherein the laminate is a wound body.

10. The film capacitor according to claim 9, wherein the wound body has an oval shape or an oblong shape.

11. The film capacitor according to claim 1, further comprising an outer case, and wherein the capacitor element is housed in an inside of the outer case.

12. The film capacitor according to claim 11, further comprising a filling resin within the outer case and filling a space between the outer case and the capacitor element.

13. The film capacitor according to claim 11, wherein the lead-out terminal projects outward from the inside of the outer case.
